(19) United States
(12) Patent Application Publication
(10) Pub. No.: US 2005/0098659 A1
(43) Pub. Date: May 12, 2005

(54) Swirl gun for powder particles

(76) Inventors: Dragoslav K. Milojevic, Bloomfield Hills, MI (US); Christopher M. Rennie, Waterford, MI (US); Melissa L. Koster, New Hudson, MI (US); Gary J. Ciarelli, Milford, MI (US); Bradford J. Muzzy, Orion, MI (US)

Correspondence Address: HARNESS, DICKEY & PIERCE, P.L.C., P.O. BOX 828, BLOOMFIELD HILLS, MI, 48303, US

(21) Appl. No.: 10/922,384

(22) Filed: Aug. 19, 2004

Related U.S. Application Data
(63) Continuation-in-part of application No. 10/259,209, filed on Sep. 27, 2002.

(51) Int. Cl. B05B 1/28; B05B 7/02; B05B 9/01; B05B 5/00

(52) U.S. Cl. 239/525; 239/526; 239/290

(57) ABSTRACT

A powder spraying gun generates a desired pattern of electrostatically charged particles for coating a workpiece without rotating parts or particle deflectors. The powder pattern is generated with a funnel-shaped output in conjunction with air introduced into a replaceable powder charging and swirling chamber of the gun. The replaceable chamber is fashioned from material exhibiting resistance to powder impact fusion and abrasion.

### CROSS REFERENCE TO RELATED APPLICATION

This is a continuation-in-part of U.S. application Ser. No. 10/259,209, filed Sep. 27, 2002 and commonly assigned.

### BACKGROUND OF THE INVENTION

The invention relates generally to spray guns for charging and distributing powders, such as electrostatically-charged powder paint particles, for deposition on the surface of a workpiece.

Conventional powder applicators are based on exterior electrostatic charging of a dispersed particle cloud as partly described in U.S. Pat. No. 5,711,489. This patent also describes means for improving the particle dispersion by a rotating airstream in the interior of the gun, as well as temperature and humidity control of the powder feeding airstream. Other conventional powder applicators are based on rotating bell cup principles such as described in U.S. Pat. No. 5,353,995.

U.S. Pat. No. 6,254,684 describes an internally charged powder spraying applicator wherein the powder is pre-charged in the interior charging chamber of the gun. The process of interior charging requires interior high voltage electrodes and at least one ground electrode. The '684 patent discloses a first design in which a round powder cloud pattern is produced by means of a round conical deflector and a second approach wherein a flat spray pattern is generated by means of a slotted nozzle. Generation of a rounded powder cloud is important in cases where a robot or some other reciprocating machine is used to move an applicator around or inside of the painted workpiece object. The cloud generator in the '684 patent has some disadvantages regarding contamination of the deflector by paint particles which leads to coating defects on the workpiece due to dripping of powder agglomerates on the surface of the workpiece. Generation of a flat spray pattern is less subject to contamination and is more widely used for flat workpiece surfaces. However, a flat pattern is more difficult to use for curved workpiece surfaces and for robotic applications, in that this design approach requires more robot arm reorientations when programming robot strokes for effecting desired surface covering.

U.S. Pat. No. 6,053,420 discloses a conical powder dispersing unit based on a tangential air/powder mixture flow which provides a round powder cloud spray pattern, yet avoids use of a deflector in the direction of the powder flow. While this approach provided an improvement to U.S. Pat. No. 5,711,489, it has nevertheless been limited to cone sizes of 50 to 170 mm. diameter which is rather large for robotic applications. Additionally, at this size, the powder cloud becomes rather “soft” in order to be moved by a robot arm. The approach disclosed in the '420 patent additionally anticipated a direct feeding from a fluidized powder bed feeder in a dense powder flow directly through a relatively small orifice.

German Published Patent Application No. 19614193 describes the combination of interior or exterior powder charging combined with exterior tangential swirl flow which is intended to produce a softer rotating round pattern powder cloud while avoiding use of deflectors in the powder stream.

While suitable for its intended applications, the spray gun disclosed in parent U.S. patent application Ser. No. 10/259,209 does suffer disadvantages of unacceptable wear of its nozzle and swirl flow creating segment of its coating chamber when used with some abrasive powders with high metal content or high coefficient of friction.

There is seen, therefore, to be a need in the art for a powder applicator with the capability for utilizing shaping air rather than deflectors, yet have the capability to maintain the powder/air mixture in a more intense motion, while minimizing abrasive damage to the powder applicator interior and spray nozzle by aggressive powder paint materials.

### SUMMARY OF THE INVENTION

In one aspect of the invention, a powder spraying gun for electrostatic powder application includes a gun body having an interior powder receiving chamber defining a surface extending along an axis of the gun body and fashioned from a material exhibiting resistance to powder impact fusion, and a replaceable output chamber having a powder swirling and charging chamber in fluid communication with the power receiving chamber and being fashioned from a material exhibiting resistance to powder abrasion and impact fusion.

In another aspect of the invention, a powder spraying gun for electrostatic powder coating application includes a gun body having a interior powder receiving chamber defining a surface extending along an axis of the gun body and fashioned from a material exhibiting resistance to powder impact fusion, a replaceable powder charging and swirling chamber in fluid communication with the powder receiving chamber and fashioned from a material exhibiting resistance to powder abrasion and impact fusion, and a replaceable gun output element terminating in a funnel-shaped output chamber in fluid communication with the powder charging and swirling chamber.

In yet another aspect of the invention, a powder spraying gun for electrostatic powder coating application includes a gun body having an interior powder charging chamber defining a surface extending along an axis of the gun body and fashioned from a material exhibiting resistance to powder abrasion and impact fusion, an output chamber having a hollow tube in fluid communication with the powder charging chamber and an annular space between the hollow tube and an outer wall of the output chamber.

### BRIEF DESCRIPTION OF THE DRAWING

The objects and features of the invention will become apparent from a reading of a detailed description, taken in conjunction with the drawing, in which:

FIG. 1 is a perspective view of a first embodiment of a powder spray gun arranged in accordance with the principles of the invention;

FIG. 2 is a longitudinal cross-sectional view of FIG. 1;

FIG. 3 is a radial cross-sectional view of the spray gun of FIG. 2 taken in the vicinity of the interior charging electrodes of the gun;

FIG. 4 is a longitudinal cross-sectional view of a second embodiment of a powder spray gun arranged in accordance with the principles of the invention;

FIG. 5 is a longitudinal cross-sectional view of a third embodiment of a powder spray gun arranged in accordance with the principles of the invention; and

FIG. 6 is a longitudinal cross-sectional view of a fourth embodiment of a powder spray gun arranged in accordance with the principles of the invention.

### DETAILED DESCRIPTION

With the arrangement to be described below, a powder paint applicator will use internal pre-charging of the powder in a chamber having a diameter substantially reduced over that of the prior art in order to maintain the powder/air mixture in a more intense motion.

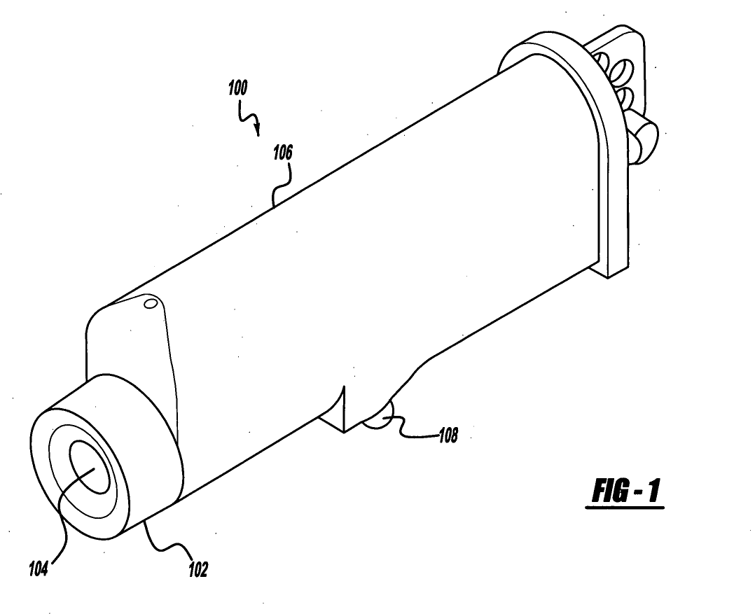

With reference to FIGS. 1-3, a powder spraying gun 100 for electrostatic powder coating application has an elongate gun body 106 extending along a longitudinal axis towards an output chamber comprised of a swirl bell cup 104 held in a cup retainer 102. A powder/air feed mixture from a powder supply enters the gun body at inlet 108.

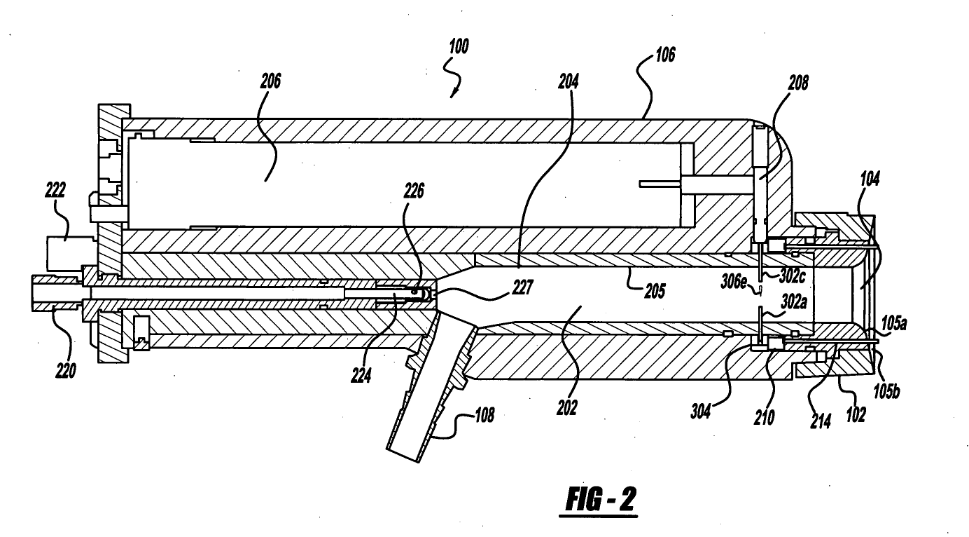

As seen more clearly from FIG. 2, gun 100 has its applicator housing 106 enclosing both a high voltage cascade 206 and a powder charging chamber 202 which provides a chamber surface 205 defined principally by a removable insert 204 fashioned from a low friction material which is resistant to powder impact fusion. Examples of such a suitable material are commercially available plastics.

A first inlet end of powder charging chamber 202 is in fluid communication with powder/air mixture supply conduit 108. Input 108 has a longitudinal axis which intersects the longitudinal axis of chamber 202 at an angle other than 90°, preferably at an angle on the order of 75°.

The inlet end of chamber 202 is also in fluid communication, via an aperture 227, with a ground electrode 224 which extends substantially along the longitudinal axis of chamber 202 from a first end of gun body 106 at a ground electrode purge air inlet 220 to an electrode tip adjacent aperture 227. Electrode 224 comprises a hollow tube-type arrangement which enables introduction of purge air at inlet 220 to flow along the interior of the tube portion of the electrode 224 to at least one purge air aperture 226 located in the cylindrical surface of the electrode and exiting the aperture so as to purge powder particles adhering to the head of electrode 224. Purge air entering the charging chamber 202 at aperture 227 assists in propelling powder particles entering at input 108 along the axis of the chamber 202.

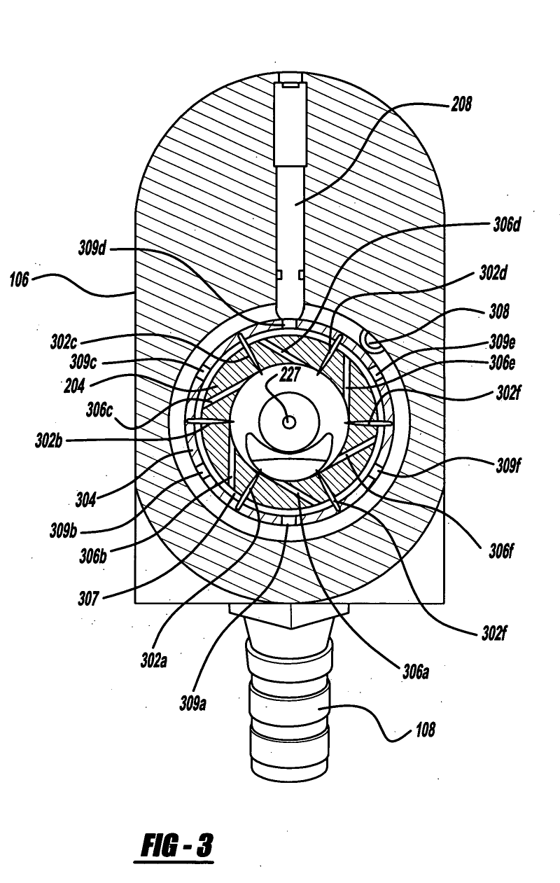

Additionally located at the first end of gun body or housing 106 is a swirl air inlet 222 adapted to be coupled to a source of compressed air for direction into the gun body to a point around the circumference of the charging chamber 202 in the vicinity of interior charging electrodes 302a-f (FIG. 3). This compressed air conduit extending from air inlet 222 of FIG. 2 is shown in FIG. 3 as 308. From 308, the air is directed through a gap between insert 204 and the gun body through a plurality of air slots 309a-f formed in electrode mounting ring 304, which is fashioned from electrically conductive plastic. Air slots 309a-f direct the compressed air into a groove. 307 formed on the interior surface of ring 304. Groove 307, in turn, causes the air to enter air conduits 306a-f which causes the air to be tangentially directed into charging chamber 202. The plurality of tangential conduits is equal in number to the plurality of interior needle charging electrodes 302a-f. In the example shown in FIG. 3, there are six needle electrodes and six tangential air conduits.

The interior needle electrodes 302 radially enter chamber 202 via conductive plastic mounting ring 304.

An important feature of air conduits 306a-f is the simultaneous dual function of same to (a) impart the desired swirling motion to the powder particles as they enter swirl bell cup 104 and (b) provide a purging air source for cleaning the portions of the needle electrodes 302 exposed to the interior of charging chamber 202.

Conductive plastic ring 304 is coupled via a high voltage conductor 208 to the high voltage cascade (or DC-to-DC voltage converter) 206 which is adapted to be coupled to a source of potential at the first end of body 106, as best shown in FIG. 2.

Swirl bell cup or output chamber 104, in conjunction with cup retainer 102 provides an output frustra-conical wall which forms a funnel-shaped outlet forming an angle of preferably on the order of about 120° to about 180°. The funnel-shaped outlet has a diameter preferably in the range of about 25 mm. to about 70 mm.

The funnel-shaped output wall is formed by a radially inward portion 105a contributed by the swirl cup 102 and by a radially outward portion 105b provided by cup retainer 102. Hence, by switching between various sized and/or angled cup retainers, the overall dimension and/or shape of the funnel-shaped output can be varied to generate a variety of powder patterns at the gun output.

Charging chamber 202 has a longitudinal length preferably on the order of about 70 to about 150 mm., while the diameter of chamber 202 lies between about 13 mm. and 20 mm., with a preferred diametrical range of on the order of 15 mm. to 17 mm.

In addition to or, optionally in place of, the interior charging electrodes 302a-f, a plurality of exterior charging needle electrodes 214 extend from a conductive plastic ring 210 surrounding chamber 202 and then through the swirl bell cup 104 to a point exterior of the funnel-shaped outlet. This arrangement is best shown in FIG. 2. The exterior charging electrodes 214 provide for electrostatic field control of the emerging powder cloud relative to a workpiece to be coated.

In operation, a powder/air mixture enters charging chamber 202 via inlet 108, wherein via ground electrode 224 and charging electrode needles 302, the powder is electrostatically charged while simultaneously set in motion in a swirl-type pattern due to the injected air via tangential ducts 306. Powder movement is also assisted in a longitudinal direction by the compressed air entering ground electrode purge air inlet 220 and exiting at hole(s) 226 at the head of ground electrode 224 in the vicinity of input 108. As the powder moves toward the outlet end of the gun chamber, the swirling air effects a desired spray pattern which is defined by controlling the ratio of the longitudinal air flow with that of the swirl pattern. The invention further contemplates varying the tangential component of air flow for generating different shapes of spray patterns and different residence times of the powder particles, thus improving charging efficiency of the resultant cloud, the width of the spray pattern and the powder transfer efficiency.

With the gun arrangement as shown and described above, more uniform electrostatic coating is effected due to improved powder dispersion. Additionally, more efficient continuous cleaning of the interior charging electrodes via the tangential air entry ports improves the efficiency of the internal charging of the powder coating material.

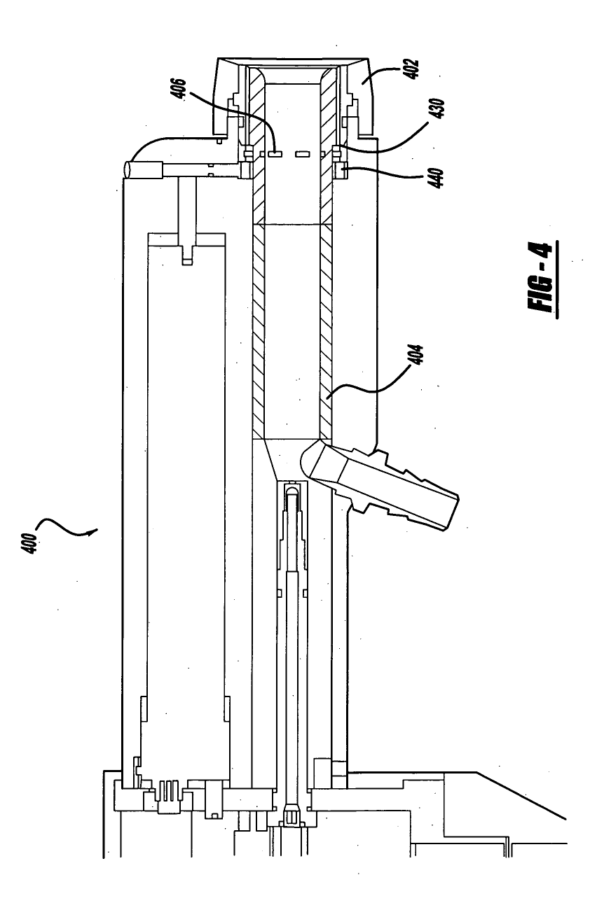

To improve the powder spray gun's resistance to abrasive damage from use of more aggressive powders, the embodiments of FIGS. 4, 5 and 6 are shown. The central theme to achieving improved abrasion resistance is to fashion at least a portion of the gun's output chamber and/or nozzle from a plastic impact fusion resistant material which is harder than that used for the powder chamber insert 205 of the spray gun of FIGS. 1-3.

With reference to FIG. 4, powder spray gun 400 is substantially similar to gun 1 00 of FIG. 2, except that it utilizes an extended swirl nozzle 430 which is separate from replaceable insert 404 which forms the powder receiving chamber. Replaceable swirl and charging nozzle 430 is fashioned from abrasion resistant material which is preferably harder than the impact fusion resistant material used for insert 404. Tangential air holes 406 impart a swirling motion to the powder inside nozzle 430 and simultaneously provide purging and cleaning air for the interior charging needles extending into the nozzle's interior from conductive plastic ring 440. Swirl cup retainer 402 is similar to retainer 102 of FIG. 2. The swirl flow spray nozzle 430 incorporates the swirl generating segment in the vicinity of the tangential air holes 406 of the charging chamber formed interior to the nozzle and enables easier replacement of abrasion worn nozzles. Additionally, abrasion wear is reduced by using harder materials than that used for the insert 404.

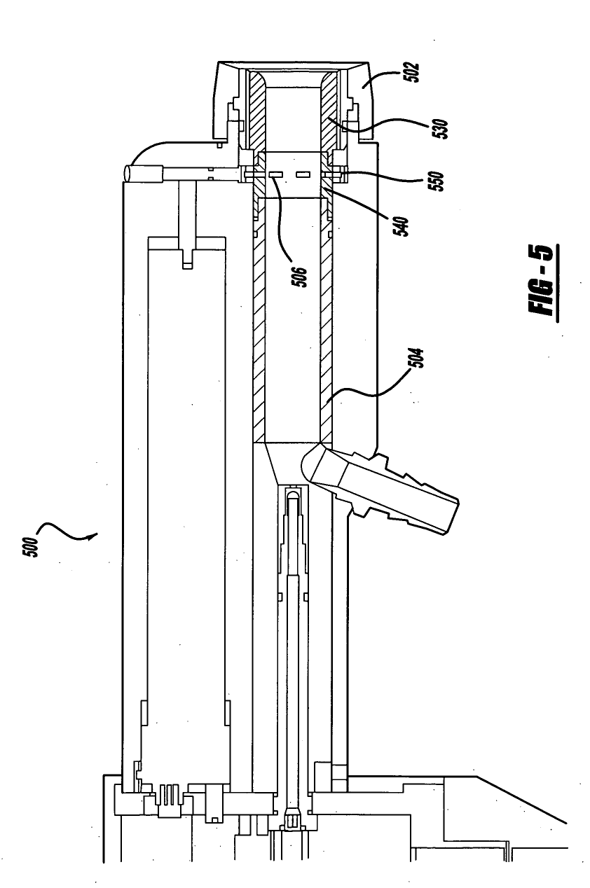

With reference to FIG. 5, powder spray gun 500 adds a replaceable abrasion resistant powder swirl and charging ring 540 intermediate low friction insert 504 forming the powder receiving chamber and a replaceable nozzle or swirl bell cup 530 retained by swirl cup retainer 502.

Again, tangential air flow holes 506 formed in abrasion resistant ring 540 provide swirling air for the powder as well as purging air for the internal electrodes mounted to conductive plastics ring 550. Ring 540 and nozzle or swirl bell cup 530 are fashioned from an abrasion resistant material, again preferably harder than the impact fusion resistant material used for powder receiving chamber insert 504.

Abrasion resistant ring 540 is the element exposed to high velocity and high momentum of the air and powder particle swirling flow. Ring segment 540 incorporates swirl air holes 506 and internal charging needle electrodes mounted to conductive plastic ring 550.

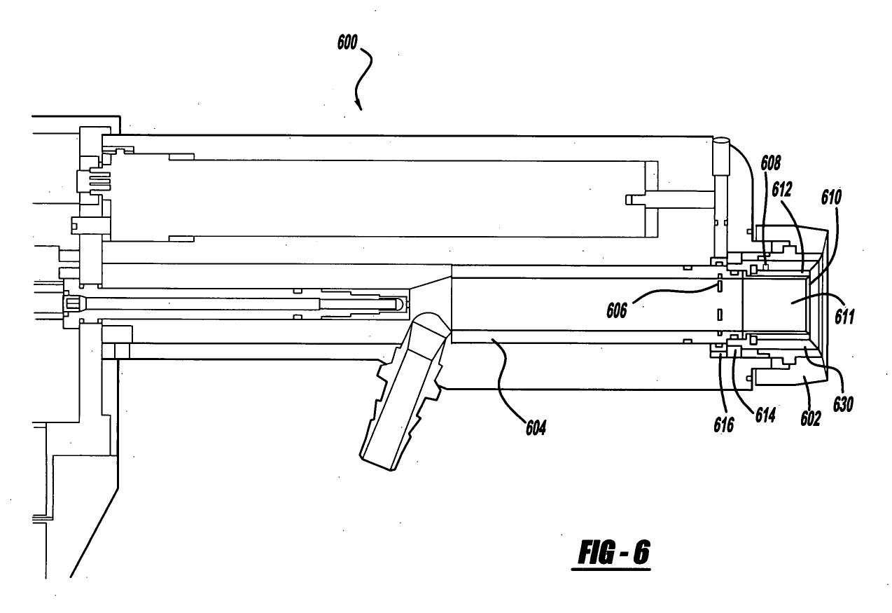

With reference to FIG. 6, rotating air flow and electrostatically pre-charged powder flow are isolated from each other until almost the exit of the gun's spray nozzle 630 and then exposing the power to the rotational air flow in the exit/diverging cone of the spray nozzle. This is done through use of tubular insert 610 which forms both a powder central flow tube 611 and a swirl flow annulus 612 formed between the wall of the nozzle 630 and the tubular swirl insert 610. This version of a powder spray gun has shown the best performance in prototype testing. A shorter insert 610 of, for example, 2 to 3 millimeters length provides the widest range of control for the spray pattern (from narrowest to widest), but the short version still has the highest risk of impact fusion or abrasion by powder on the nozzle exit cone. A long insert 610, for example, 15 to 20 millimeters length, shows the least exposure to power abrasion or impact fusion, but has a limited range of spray pattern control (only large and medium spray pattern widths appear possible). A medium length insert of, for example, 5 to 10 millimeters is recommended in most cases as a compromise for minimizing both impact fusion and abrasion on the one hand and maximization of control of the spray pattern on the other hand.

Once the length of insert 611 is optimized for a specific powder composition for a specific application, it is desirable to integrate charging chamber 604 with insert 611 as a single piece replaceable unit to eliminate gaps in the powder path walls in the charging chamber.

The invention has been described with respect to an exemplary embodiment and the details of same are to be taken for the sake of example only. The scope and spirit of the invention are as set forth in appropriately interpreted claims.

1. A powder spraying gun for electrostatic powder application comprising:
a gun body having an interior powder receiving chamber defining a surface extending along an axis of the gun body and fashioned from a material exhibiting resistance to powder impact fusion; and
a replaceable output chamber having a powder swirling and charging chamber in fluid communication with the powder receiving chamber and being fashioned from a material exhibiting resistance to powder abrasion and impact fusion.

2. The powder spraying gun of claim 1 wherein material from which the output chamber is fashioned is harder than the material from which the powder receiving chamber is fashioned.

3. The powder spraying gun of claim 1 wherein the replaceable output chamber includes a funnel-shaped gun output.

4. The powder spraying gun of claim 1 further comprising:
a compressed air inlet adapted for coupling to a source of compressed air; and
a plurality of air conduits each tangentially opening at the surface of the replaceable output chamber between pairs of a plurality of interior charging electrodes and in fluid communication with the compressed air inlet for introducing air in a swirling pattern into the charging chamber for imparting a swirling motion to powder particles and for purging powder particles adhering to exposed surfaces of the interior charging electrodes.

5. A powder spraying gun for electrostatic powder coating application comprising:
a gun body having an interior powder receiving chamber defining a surface extending along an axis of the gun body and fashioned from a material exhibiting resistance to powder abrasion and impact fusion;
a replaceable powder charging and swirling chamber in fluid communication with the powder receiving chamber and fashioned from a material exhibiting resistance to powder abrasion and impact fusion; and
a replaceable gun output element terminating in a funnel-shaped output chamber in fluid communication with the powder charging and swirling chamber.

6. The powder spraying gun of claim 5 further comprising:
a compressed air inlet adapted for coupling to a source of compressed air;
a plurality of air conduits each tangentially opening at the surface of the powder charging and swirling chamber between pairs of a plurality of interior charging electrodes and in fluid communication with the compressed air inlet for introducing air in a swirling pattern into the charging and swirling chamber for imparting a swirling motion to powder particles and for purging powder particles adhering to exposed surfaces of the interior charging electrode.

7. A powder spraying gun for electrostatic powder coating application comprising:
a gun body having an interior powder charging chamber defining a surface extending along an axis of the gun body and fashioned from a material exhibiting resistance to powder abrasion and impact fusion; and
an output chamber having a hollow tube in fluid communication with the powder charging chamber and an annular space between the hollow tube and an outer wall of the output chamber.

8. The powder spraying gun of claim 7 wherein the hollow tube comprises a removably replaceable insert fabricated from a material exhibiting resistance to power abrasion and impact fusion.

9. The powder spraying gun of claim 7 further comprising air conduits each tangentially opening at a surface of the outer wall facing the annular space for introducing air in a swirling pattern into the annular space for imparting a swirling motion to powder particles exiting the hollow tube.

10. The powder spraying gun of claim 9 further comprising a funnel-shaped output in fluid communication with the hollow tube and the annular space.

11. The powder spraying gun of claim 7 wherein the powder charging chamber and the hollow tube are integrally fabricated as a single-piece replaceable unit fashioned from a material exhibiting resistance to powder abrasion and impact fusion.
